(19) United States
(12) Patent Application Publication
(10) Pub. No.: US 2026/0131986 A1
(43) Pub. Date: May 14, 2026

(54) CONTAINER DISPENSING SYSTEM

(71) Applicant: Amir Murphy, Chicago, IL (US)

(72) Inventor: Amir Murphy, Chicago, IL (US)

(21) Appl. No.: 18/948,452

(22) Filed: Nov. 14, 2024

(51) Int. Cl. B65G 65/02

(52) U.S. Cl. CPC B65G 65/02; B65G 2812/02; B65G 2812/12

(57) ABSTRACT

A system including a housing with a housing wall extending between a housing first end and a housing second end, a tray pivotably coupled to the housing, an arm pivotably coupled to the housing, and a first actuator and a second actuator positioned on the outer surface of the housing. A first opening, defined by the housing wall, is positioned proximate the housing second end. The first actuator is coupled to the tray and actuatable between a first actuator first position, causing the tray to pivot to a first tray position, and a first actuator second position, causing the tray to pivot to a second tray position. The second actuator is coupled to the arm and actuatable between a second actuator first position, causing the arm to pivot to a first arm position, and a second actuator second position, causing the arm to pivot to a second arm position.

### FIELD

The present invention relates generally to the field of dispensing systems. More specifically dispensing systems for storing and dispensing storage containers.

### BACKGROUND

Storage containers are used to store a variety of items, such as, but not limited to, various food items. Storage systems for storage containers allow a user to organize the containers and allow the user to find a desired container size. Storage systems are intended to maximize space, which can allow the user to include other items in their cabinets or on their counters.

### SUMMARY

One embodiment relates to a system including a housing with a housing wall, a tray pivotably coupled to the housing, an arm pivotably coupled to the housing, a first actuator positioned on an outer surface of the housing, and a second actuator positioned on the outer surface of the housing. The housing wall extends from a housing first end to a housing second end and defines a first opening positioned proximate the housing second end. The tray is positioned proximate the first opening, the tray repositionable between a first tray position and a second tray position. The arm is positioned between the first opening and the housing first end, the arm repositionable between a first arm position and a second arm position. The first actuator is coupled to the tray and is actuatable between a first actuator first position, causing the tray to pivot to the first tray position, and a first actuator second position, causing the tray to pivot to the second tray position. The second actuator is coupled to the arm and is actuatable between a second actuator first position, causing the arm to pivot to the first arm position, and a second actuator second position, causing the arm to pivot to the second arm position.

Another embodiment relates to a system including a housing including a tray pivotable coupled to the housing, an arm pivotable coupled to the housing and a first storage container. The housing includes a housing first end and a housing second end and defines a first volume and a first opening in communication with the first volume. The tray is positioned within the first volume and positioned proximate the first opening, where the tray is repositionable between a first tray position and a second tray position. The tray contacts the first storage container when the tray is in the first tray position. The arm is positioned within the first volume and positioned between the housing first end and housing second end, where the arm is repositionable between a first arm position and a second arm position. The first storage container is positionable within the first volume.

Yet another embodiment of the invention relates to a method of dispensing storage containers. The method includes providing a dispensing system, positioning storage containers within a first volume, and actuating a second actuator from a second actuator first position to a second actuator second position, causing an arm to contact a second storage container. The dispensing system includes a housing defining the first volume and a first opening, a tray pivotably coupled to the housing within the first volume, the arm pivotably coupled to the housing within the first volume, a first actuator positioned on an outer surface of the housing and coupled to the tray, and the second actuator positioned on the outer surface of the housing and coupled to the arm. The tray is repositionable between a first tray position and a second tray position. The arm is repositionable between a first arm position and a second arm position. The first actuator is actuatable between a first actuator first position, causing the tray to pivot to the first tray position, and a first actuator first position, causing the tray to pivot to the second tray position. The second actuator is actuatable between the first actuator first position, causing the arm to pivot to the first arm position, and the second actuator second position, causing the arm to pivot to the second arm position. The method further includes the tray contacting the first storage container when the storage containers are positioned within the first volume.

### BRIEF DESCRIPTION OF THE DRAWINGS

FIG. 1 is a perspective view of a dispensing system, according to an example embodiment.

FIG. 2 is a front sectional view showing a portion of the dispensing system of FIG. 1, shown in a first configuration.

FIG. 3 is another front sectional view showing a portion of the dispensing system of FIG. 1, shown in a second configuration.

FIG. 4 is yet another front sectional view showing a portion of the dispensing system of FIG. 1, shown in a third configuration.

FIG. 5 is a front sectional view showing a portion of the dispensing system of FIG. 1, shown in the third configuration.

FIG. 6 is another front sectional view showing a portion of the dispensing system of FIG. 1, shown in a fourth configuration.

FIG. 7 is yet another front sectional view showing a portion of the dispensing system of FIG. 1, shown in a fifth configuration.

FIG. 8 is a side sectional view showing a portion of the dispensing system of FIG. 1, shown in the third configuration.

FIG. 9 is another side sectional view showing a portion of the dispensing system of FIG. 1, shown in the fourth configuration.

FIG. 10 is yet another side sectional view showing a portion of the dispensing system of FIG. 1, shown in the fifth configuration.

FIG. 11 is a perspective view showing a portion of the dispensing system of FIG. 1.

FIG. 12 is a flowchart showing the actuator operation of the dispensing system of FIG. 1.

FIG. 13 is a perspective view of a dispensing system, according to another example embodiment.

FIG. 14 is a front sectional view showing a portion of the dispensing system of FIG. 13, shown in a first configuration.

FIG. 15 is a front sectional view showing a portion of the dispensing system of FIG. 13, shown in a second configuration.

FIG. 16 is a rear view of a dispensing system, according to yet another example embodiment.

### DETAILED DESCRIPTION

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

Embodiments described herein relate generally to a dispensing system. The dispensing system is used to store and release storage containers through the operation of a first actuator and a second actuator. The storage containers can be, for example, collapsible food storage containers.

Referring generally to the figures, a dispensing system for storage containers is described. The dispensing system includes actuators such as buttons that, when operated, release a single storage container from a storage queue to a retrieval area. A user can then retrieve the container from the retrieval area. The dispensing system includes inner sections that each contain storage containers of a predetermined size. The dispensing system allows the user to retrieve the single storage container of a predetermined size more quickly.

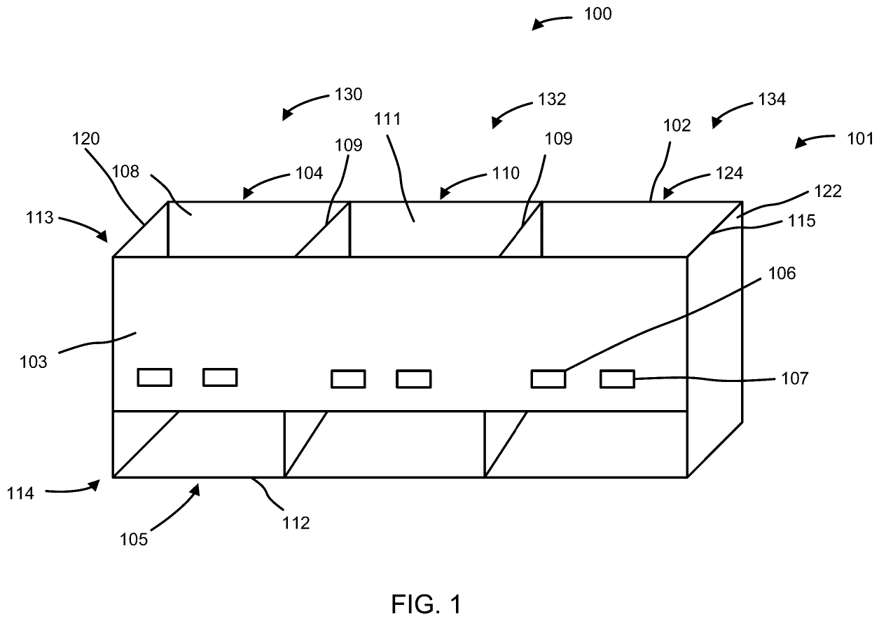

Referring to FIG. 1, a system 100 includes a housing 101 defining a housing wall 115 that extends between a housing first end 113 and a housing second end 114. The housing wall 115 includes a first wall 102 (e.g., a rear wall) extending from the housing first end 113 to the housing second end 114. The housing wall 115 includes a second wall 103 (e.g., a front wall) spaced away from the first wall 102 such that a first volume 104 is at least partially defined between the first wall 102 and the second wall 103. The second wall 103 extends from the housing first end 113 towards the housing second end 114 such that the second wall 103 at least partially defines a first opening 105. The first opening 105 is positioned proximate the housing second end 114. The housing 101 further defines a second opening 108 located proximate the housing first end 113 and defined between the first wall 102 and the second wall 103.

The housing 101 includes a third wall 109 (e.g., longitudinal wall, a central wall, etc.) extending between the first wall 102 and the second wall 103 such that the first volume 104 is defined by the first wall 102, the second wall 103, and a first side of the third wall 109. A second volume 110 is defined between the first wall 102, the second wall 103, and a second side of the third wall 109. The second volume 110 extends from the housing first end 113 towards the end of the second wall 103.

In some embodiments, the housing 101 includes multiple third walls 109. For example, as shown in FIG. 1, the housing 101 includes two third walls 109. Each of the third walls 109 is spaced apart from each other such that a volume (e.g., the second volume 110) is defined between adjacent third walls 109. In other embodiments, the housing 101 may include more or fewer third walls 109 than as shown in FIG. 1.

The second opening 108 is defined between the first wall 102, the second wall 103, and the first side of the third wall 109. A third opening 111 is defined between the first wall 102, the second wall 103, and a second side of the third wall 109. The second opening 108 and the third opening 111 are positioned proximate the housing first end 113.

The housing 101 further includes a first actuator 106, such as a button, positioned on an outer side of the second wall 103. The first actuator 106 is actuatable between a first actuator first position and a first actuator second position. In some embodiments, the first actuator 106 may be positioned towards the center of the outer side of the second wall 103.

The housing 101 further includes a second actuator 107, such as a button, positioned on the outer side of the second wall 103. The second actuator 107 is actuatable between a second actuator first position and a second actuator second position. In some embodiments, the second actuator 107 may be positioned towards the center of the outer side of the second wall 103.

In some embodiments, the second actuator 107 and the first actuator 106 may be configured such that the first actuator 106 and the second actuator 107 are aligned along the same axis. In other embodiments, the housing 101 includes a single actuator (e.g., either the first actuator 106 or the second actuator 107) that is configured to perform the functions of both the first actuator 106 and the second actuator 107 described herein.

The housing 101 further includes a fourth wall 112 (e.g., a bottom wall) positioned at the housing second end 114 and extending from the first wall 102 towards the second wall 103. The first opening 105 is defined by the second wall 103 and the fourth wall 112. The housing 101 may define multiple first openings 105 defined by at least the first wall 102 and the fourth wall 112.

The housing 101 includes a fifth wall 120 (e.g., a first side wall) positioned at a first lateral side of the housing 101 and extending between the first wall 102 and the second wall 103 and spaced away from the third wall 109 such that the first volume 104 is defined by the first wall 102, the second wall 103, the first side of the third wall 109, and the fifth wall 120. The fifth wall 120 is a first side wall of the housing 101, such that an exterior surface of the fifth wall 120 is an exterior surface of the housing 101.

The housing 101 includes a sixth wall 122 (e.g., a second side wall) positioned at a second lateral side of the housing 101, opposite the first lateral side, and extending between the first wall 102 and the second wall 103 and positioned opposite the fifth wall 120. The sixth wall 122 is a second side wall of the housing 101, such that an exterior surface of the sixth wall 122 is an exterior surface of the housing 101.

As shown in FIG. 1, the first wall 102, the second wall 103, the third walls 109, the fourth wall 112, the fifth wall 120, and/or the sixth wall 122 cooperate in various combinations to define one or more volumes, shown as the first volume 104, the second volume 110 and a third volume 124. In other embodiments, the housing 101 may define more or fewer volumes. When the housing 101 defines fewer volumes, the housing 101 includes fewer third walls 109. By way of the example, the housing 101 includes one third wall 109 when the housing 101 defines two volumes, and the housing 101 does not include the third wall 109 when the housing 101 defines one volume. In another example, when the housing defines more volumes, the housing 101 includes additional third walls 109, where each additional third wall defines one additional volume. Additionally, as the housing 101 defines more or fewer volumes the length of the first wall 102, the second wall 103, and the fourth wall 112 may be adjusted to accommodate the number of volumes.

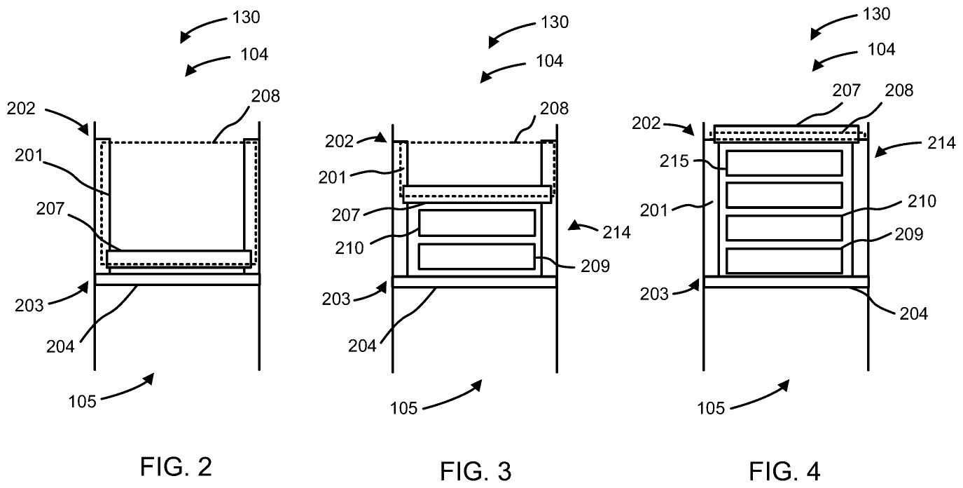

As shown in FIG. 1, the housing 101 includes one or more dispensers, shown as a first dispenser 130, a second dispenser 132, and a third dispenser 134. In other embodiments, the housing 101 may include more or fewer dispensers. The first dispenser 130 is shown in FIGS. 2-11 and is described in greater detail herein below. It should be understood that the second dispenser 132 and the third dispenser 134 are substantially similar to or the same as the first dispenser and may include the same or similar features shown in FIGS. 2-11 and described below.

As shown in FIGS. 2-11, the system 100 includes a track 201 positionable on an inner surface of the housing 101. As shown in FIGS. 2-4 and 11, the track 201 includes a track first end 202 positioned proximate the housing first end 113. Still referring to FIGS. 2-4 and 11, the track 201 includes a track second end 203 positioned proximate the first opening 105. As shown in FIGS. 2-4 and 11, the track second end 203 is positioned above the first opening 105.

As shown in FIGS. 2-11, the system 100 includes a plate 207 that is coupled to the track 201. The plate 207 is movable relative to the track 201. In particular, the plate 207 is movable between the track first end 202 and the track second end 203.

As shown in FIGS. 2-11, the system 100 includes a biasing member 208 is positioned proximate the track 201. The biasing member 208 biases the plate 207 towards the track second end 203. In some embodiments, the biasing member 208 is positioned within the track 201. In some embodiments, the biasing member 208 is coupled to the plate 207.

As shown in FIGS. 2-11, the system 100 includes a tray 204 that is pivotably coupled to the inner surface of the housing 101. The tray 204 is positioned proximate the first opening 105. In some embodiments, the tray 204 is pivotably coupled to the first wall 102 proximate the first opening 105. In other embodiments, the tray 204 is pivotably coupled to one of the third wall 109 or the second wall 103, proximate the first opening 105.

As shown in FIGS. 3-10, the housing 101 is configured to receive one or more storage containers 214. In some embodiments, the storage containers 214 are food storage containers. In other embodiments, the storage containers 214 are collapsible food storage containers. In some embodiments, the housing 101 is configured to receive different types of storage containers 214. Each type of storage containers 214 can have a different size or material. When the storage containers 214 are received in the housing 101, the tray 204 contacts a first storage container 209 of the storage containers 214. As shown in FIGS. 4-10, when the storage containers 214 are positioned in the housing 101, the biasing member 208 biases the plate 207, such that the plate 207 contacts one of the storage containers 214, shown as a fourth storage container 215.

As shown in FIGS. 4-6, when the storage containers 214 are positioned in the housing 101, the plate 207 is positioned proximate the track first end 202 within the first volume 104 of the housing 101. The tray 204, positioned proximate the track second end 203, is in contact with the first storage container 209. Although FIGS. 4-6 displays four storage containers, in other embodiments, the housing 101 may be configured to receive more or fewer storage containers 214 within the first volume 104.

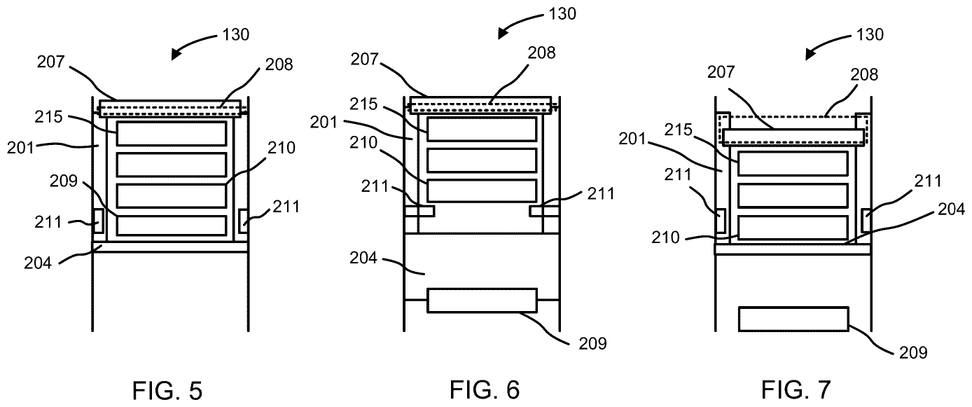

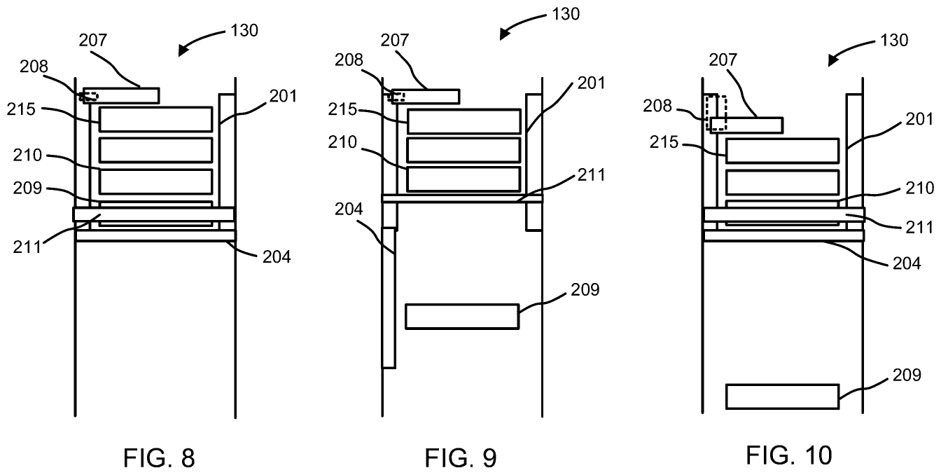

Referring generally to FIGS. 5-10, views of the system 100 are shown in varying configurations. In particular, FIGS. 5-10 depict how the system 100 dispenses a single storage container, such as the first storage container 209. A second storage container 210 is located proximate the first storage container 209. As shown in FIGS. 5 and 8, the second storage container 210 is located directly above the first storage container 209.

As described above, the tray 204 is pivotably coupled to the housing 101. The tray 204 is movable between a first tray position and a second tray position. As shown in FIGS. 5, 7, 8, and 10, in the first tray position, the tray 204 extends in a substantially horizontal direction. When the tray 204 is in the first tray position, the tray 204 supports the first storage container 209 and substantially prevents the first storage container 209 from falling (e.g., due to gravity). As shown in FIGS. 6 and 9, in the second tray position, the tray 204 extends in a substantially vertical direction. When the tray 204 is in the second tray position, the tray 204 releases the first storage container 209, such that the first storage container 209 falls (e.g., due to gravity).

As shown in FIGS. 5-10, the system 100 includes an arm 211 pivotably coupled to the housing 101. The arm 211 is movable between a first arm position and a second arm position. In some embodiments, the system 100 includes multiple arms 211 (e.g., two or more arms 211). In the first arm position, the arm 211 extends in a substantially vertical direction. When the arm 211 is in the first arm position, the arm 211 does not contact any of the storage containers 214. In the second arm position, the arm 211 extends in a substantially horizontal direction. When the arm 211 is in the second arm position, the arm 211 contacts the second storage container 210 and substantially prevents the second storage container 210 from falling (e.g., due to gravity). When the arm 211 is in the second arm position, the arm 211 extends in a horizontal direction (e.g., in a direction perpendicular to the first wall 102). When the arm 211 is in the first arm position, the arm 211 extends in a vertical direction.

Referring to FIGS. 5 and 8, the tray 204 is shown in the first tray position, and the arm 211 is shown in the first arm position. The tray 204 contacts and supports the first storage container 209 and substantially prevents the first storage container 209 from falling due to gravity. The arm 211 is positioned away from the storage containers 214, such that the arm 211 does not contact the storage containers 214.

Referring to FIGS. 6 and 9, the tray 204 is shown in the second tray position, and the arm 211 is shown in the second arm position. When the tray 204 is in the second tray position, the first storage container 209 is not supported by the tray 204 and falls vertically downward (e.g., due to gravity). The first storage container 209 falls towards the first opening 105. When the arm 211 is in the second arm position, the arm 211 contacts and supports the second storage container 210, such that the arm 211 substantially prevents the second storage container 210 (and the storage containers 214 positioned vertically above the second storage container 210) from falling.

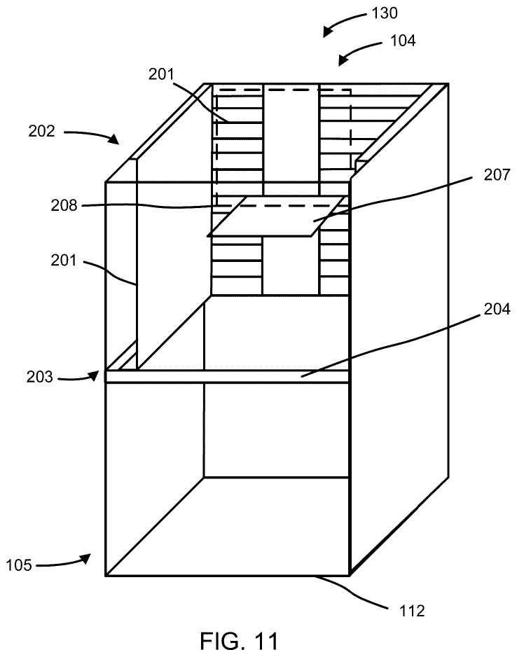

Referring to FIGS. 7 and 10, the tray 204 is shown in the first tray position and the arm 211 is shown in the first arm position. The first storage container 209 is located proximate the first opening 105 and rests on the fourth wall 112. As the arm 211 pivots from the second arm position to the first arm position, the second storage container 210 is released from the arm 211. The tray 204, in the first tray position, catches the second storage container 210 and substantially prevents the second storage container 210 from falling further. That is, the second storage container 210 may fall a short distance defined between the arm 211 and the tray 204. However, the tray 204 substantially prevents the second storage container 210 from falling further. The biasing member 208 biasing the plate 207 towards the tray 204, such that the second storage container 210 is retained between the tray 204 and the plate 207.

Referring to FIG. 11, the housing 101 includes the track 201 positioned on the inner surface of the housing 101, the plate 207 coupled to the track 201 and positioned between the track first end 202 and the track second end 203 and the tray 204 coupled to the housing 101 and positioned proximate the track second end 203. The housing 101 also includes the fourth wall 112 and defines the first opening 105.

The first actuator 106 is coupled to the tray 204. When the first actuator 106 is in the first actuator first position, the first actuator 106 causes the tray 204 to be in the first tray position. When the first actuator 106 is in the first actuator second position, the first actuator 106 causes the tray 204 to be in the second tray position. In this way, actuation of the first actuator 106 from the first actuator first position to the first actuator second position causes the tray 204 to pivot from the first tray position to the second tray position.

The second actuator 107 is coupled to the arm 211. When the second actuator 107 is in the second actuator first position, the second actuator 107 causes the arm 211 to be in the first arm position. When the second actuator 107 is in the second actuator second position, the second actuator 107 causes the arm 211 to be in the second arm position. In this way, the actuation of the second actuator 107 from the second actuator first position to the second actuator second position causes the arm 211 to pivot from the first arm position to the second arm position.

In some embodiments, the second actuator 107 prevents the first actuator 106 from being actuated from the first actuator first position to the first actuator second position when the second actuator 107 is in the second actuator first position. Advantageously, preventing the first actuator 106 from being actuated from the first actuator first position to the first actuator second position when the second actuator 107 is in the second actuator first position substantially prevents the storage containers 214 from unintentionally falling towards the first opening 105.

In other embodiments, the first actuator 106 prevents the second actuator 107 from being actuated from the second actuator second position to the second actuator first position when the first actuator 106 is in the first actuator second position. Advantageously, preventing the second actuator 107 from being actuated from the second actuator second position to the second actuator first position when the first actuator 106 is in the first actuator second position substantially prevents the other storage containers 214 from unintentionally falling towards the first opening 105.

In some embodiments, the operation of the first actuator 106 and second actuator 107 operates to release the first storage container 209 while storing the second storage container 210, and any other storage containers 214 above the second storage container 210, within the housing 101 and above the track second end 203 and/or above the first opening 105.

The embodiments shown in FIGS. 2-11 and described herein relate to the first dispenser 130. The second dispenser 132 and the third dispenser 134 may be substantially similar to or the same as the first dispenser 130. For example, the descriptions related to the first dispenser 130 may apply to the second dispenser 132 and the third dispenser 134.

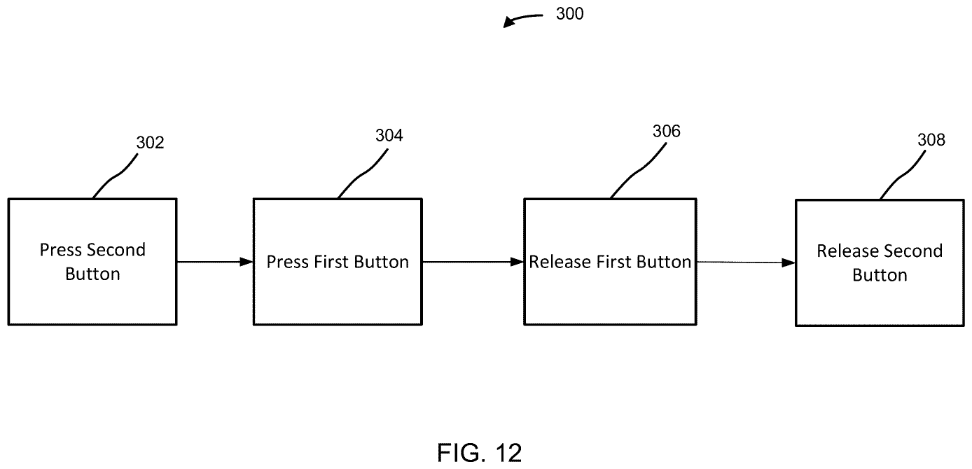

Now referring to FIG. 12, a flow diagram of a method 300 of operating the system 100 is shown, according to an example embodiment. In some embodiments, a user may perform the method 300. As shown, the method 300 includes operating the first actuator 106 and second actuator 107 of the dispensing system 100 to dispense one or more storage containers 214 such as the first storage container 209. It should be understood that certain processes of the method 300 may be combined in other embodiments; implemented in a different order than depicted in other embodiments; and, in some embodiments, certain of the method 300 processes may be deleted/omitted.

At the beginning of the method 300, the storage containers 214 are positioned within the housing 101 and are located at or above the track second end 203 and/or the first opening 105. The first actuator 106 is in the first actuator first position, causing the tray 204 to be positioned at the first tray position. When the tray 204 is in the first tray position, the tray 204 contacts the first storage container 209. The second actuator 107 is in the second actuator first position, causing the arm 211 to be positioned at the first arm position. When the arm 211 is in the first arm position, the arm 211 is positioned away from the storage containers 214, such that the arm 211 does not contact the storage containers 214.

At process 302, the second actuator 107 is actuated from the second actuator first position to the second actuator second position, causing the arm 211 to pivot from the first arm position to the second arm position. When the arm 211 pivots from the first arm position to the second arm position, the arm 211 contacts the second storage container 210 of the storage containers 214.

At process 304, subsequent to actuating the second actuator 107 from the second actuator first position to the second actuator second position, the first actuator 106 is actuated from the first actuator first position to the second actuator second position, causing the tray 204 to pivot from the first tray position to the second tray position. The actuation of the tray 204 from the first tray position to the second tray position causes the tray 204 to release the first storage container 209. The first storage container 209 is released into the first opening 105. The first storage container 209 is located proximate the fourth wall 112 subsequent the release of the first storage container 209 from the tray 204. When the tray 204 releases the first storage container 209, the second storage container 210 remains in contact with the arm 211. The arm 211 prevents the second storage container 210 from falling.

At process 306, subsequent to actuating the first actuator 106 from the first actuator first position to the first actuator second position, the first actuator 106 is actuated from the first actuator second position to the first actuator first position, causing the tray 204 to pivot from the second tray position to the first tray position. Pivoting the tray 204 from the second tray position to the first tray position substantially prevents the storage containers 214 from being released into the first opening 105.

At process 308, subsequent to actuating the first actuator 106 from the first actuator second position to the first actuator first position, the second actuator 107 is actuated from the second actuator second position to the second actuator first position, causing the arm 211 to pivot from the second arm position to the first arm position. When the arm 211 pivots from the second arm position to the first arm position, the arm 211 is stowed and the plate 207 biases the second storage container 210, and any additional storage containers 214, towards the tray 204 until the second storage container 210 comes in contact with the tray 204. The method 300 may be repeated for each storage container 214 within the system 100.

Although FIGS. 2-10 depict the storage containers as having a similar volume, other embodiments are also within the scope of the innovation disclosed herein, which is not intended to be limited by the images and specific examples discussed and shown. For example, embodiments with storage containers of a smaller volume and embodiments with storage containers of a larger volume are possible. Further, the storage containers may have different structural forms than the rectangular or cubical form depicted in FIGS. 2-10. For example, embodiments with storage containers of circular shape and storage containers of cylindrical shape are possible.

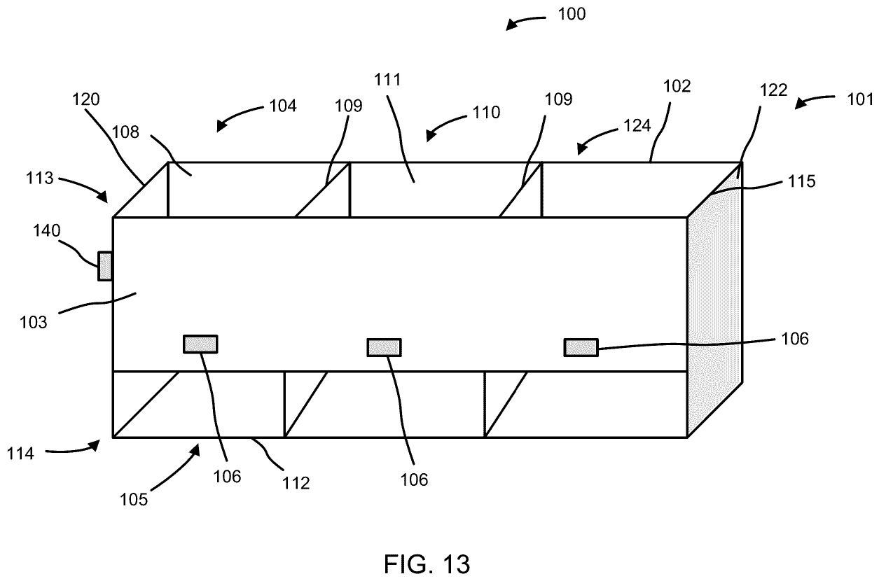

Referring to FIGS. 13-15, the housing 101 is shown according to another example embodiment. In the embodiment shown in FIGS. 13-15, the housing 101 is substantially similar to the housing 101 shown in FIGS. 1-11. For example, the housing 101 includes the housing wall 115, which includes the first wall 102, the second wall 103, the third wall 109, the fourth wall 112, the fifth wall 120, and the sixth wall 122. The corresponding openings and volumes that are defined by the housing wall 115 are also substantially the same (e.g., the first volume 104, the second volume 110, the third volume 124, the first opening 105, the second opening 108, the third opening 111, the housing first end 113, and the housing second end 114). The housing 101 also includes the first actuator 106, the first dispenser 130, the second dispenser 132, and the third dispenser 134. Each of the first dispenser 130, the second dispenser 132, and the third dispenser 134 includes a corresponding track 201, tray 204, plate 207, and biasing member 209. Additionally, each of the first dispenser 130, the second dispenser 132, and the third dispenser 134 is configured to store one or more storage containers 214 (e.g., a first storage container 209, a second storage container 210, a fourth storage container 215, etc.). In contrast with the housing 101 shown in FIGS. 1-11, the housing 101 shown in FIGS. 13-15 includes a third actuator 140 that is different than the second actuator 107 and an arm 240 that is different than the arm 211.

As shown in FIGS. 13-15, the system 100 includes a third actuator 140, such as a lever or knob. In the embodiment shown in FIGS. 13-15, the third actuator 140 is positioned on a lateral side (e.g., a first lateral side) of the housing 101. More specifically, as shown in FIGS. 13-15, the third actuator 140 is positioned on the fifth wall 120. In some embodiments, the third actuator 140 may be positioned towards a center of the outer side of the fifth wall 120. In other embodiments, the third actuator 140 may be positioned on the sixth wall 122 (e.g., a second lateral side, opposite the first lateral side). The third actuator 140 is actuatable between a third actuator first position and a third actuator second position. In some embodiments, the third actuator 140 may be configured such that the first actuator 106 and the third actuator 140 are aligned along the same axis.

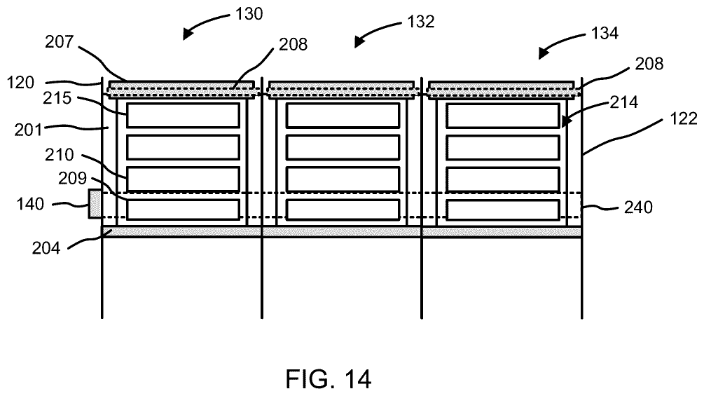

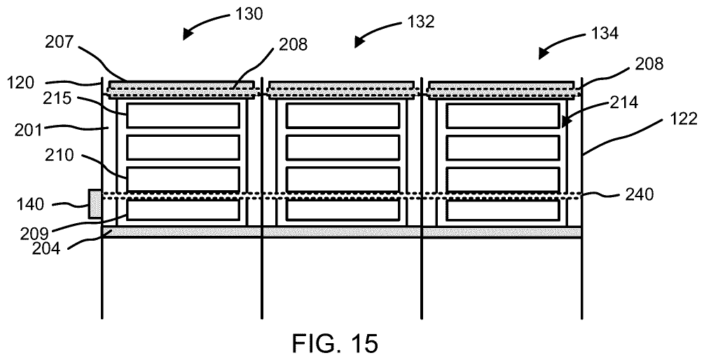

As shown in FIGS. 14-15, the system 100 includes an arm 240 pivotably coupled to the housing 101. The arm 240 extends laterally across the housing 101 (e.g., from the housing first end 113 to the housing second end 114). That is, the arm 240 extends into each of the first dispenser 130, the second dispenser 132, and the third dispenser 134. The arm 240 is movable between a first arm position and a second arm position. As shown in FIG. 14, in the first arm position, the arm 240 extends in a substantially vertical direction. When the arm 240 is in the first arm position, the arm 240 does not contact any of the storage containers 214. As shown in FIG. 15, in the second arm position, the arm 240 extends in a substantially horizontal direction. When the arm 140 is in the second arm position, the arm 240 contacts the second storage container 210 and substantially prevents the second storage container 210 from falling (e.g., due to gravity). More specifically, the arm 240 contacts the second storage container 210 in each of the first dispenser 130, the second dispenser 132, and the third dispenser 134, simultaneously.

Accordingly, the arm 240 is similar in function to the arm 211. In contrast with the arm 211, however, the arm 240 extends into each of the first dispenser 130, the second dispenser 132, and the third dispenser 134 simultaneously, as shown in FIGS. 14 and 15. Said another way, the arm 240 extends from the housing first end 113 to the housing second end 114 such that the arm extends into the first volume 104, the second volume 110, and the third volume 124.

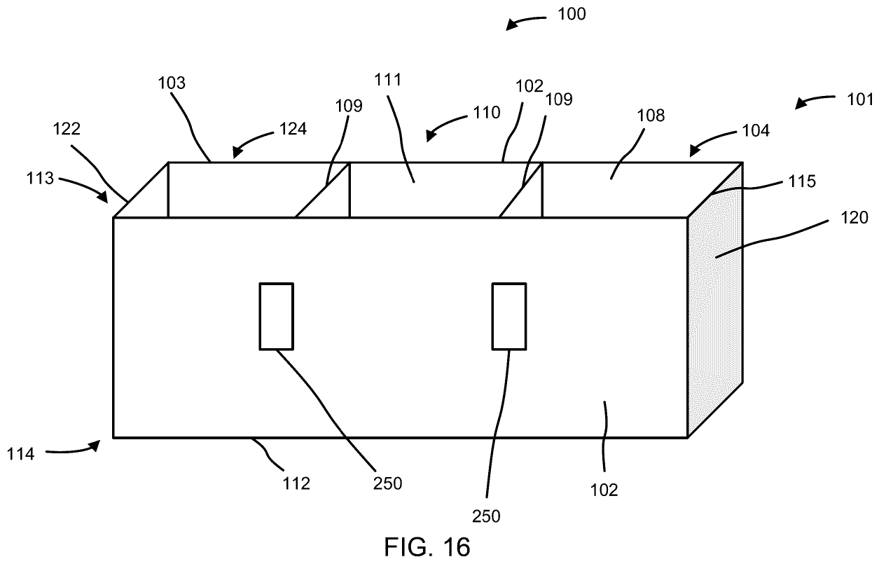

Referring to FIG. 16, the housing 101 is shown according to another example embodiment. As shown in FIG. 16, the housing 101 includes one or more mounting members 250. The one or more mounting members 250 are positioned on the first wall 102. As shown, the housing 101 includes two mounting members 250. In other embodiments, the housing 101 may include more or fewer (e.g., at least one) mounting members 250. The one or more mounting members 250 are configured to facilitate coupling the housing 101 to a surface, such as a wall, an inside of a cabinet, or other substantial vertical surface. The one or more mounting members 250 may include, for example, a loop and hook member, a triangle hook member, a circle hook member, a keyhole member, a sawtooth hook member, a t-hook member, an interlocking slot member, a rope, wire, or chain member, or any other suitable mounting device.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The term “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other example embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A system comprising:
a housing comprising a housing wall extending between a housing first end and a housing second end, the housing wall defining a first opening positioned proximate the housing second end;
a tray pivotably coupled to the housing and positioned proximate the first opening, the tray repositionable between a first tray position and a second tray position;
an arm pivotably coupled to the housing and positioned between the first opening and the housing first end, the arm repositionable between a first arm position and a second arm position;
a first actuator positioned on an outer surface of the housing, the first actuator coupled to the tray, the first actuator actuatable between a first actuator first position whereby the first actuator causes the tray to pivot to the first tray position and a first actuator second position whereby the first actuator causes the tray to pivot to the second tray position; and
a second actuator positioned on the outer surface of the housing, the second actuator coupled to the arm and actuatable between a second actuator first position whereby the second actuator causes the arm to pivot to the first arm position and a second actuator second position whereby the second actuator causes the arm to pivot to the second arm position.

2. The system of claim 1, wherein the housing is configured to receive a plurality of storage containers within the housing, such that the tray contacts a first storage container of the plurality of storage containers when the tray is in the first tray position.

3. The system of claim 2, wherein the housing wall comprises:
a first wall extending from the housing first end to the housing second end; and
a second wall spaced away from the first wall such that a first volume is at least partially defined between the first wall and the second wall, the second wall extending from the housing first end towards the housing second end such that the second wall at least partially defines the first opening;
wherein the first wall and the second wall define a second opening located proximate the housing first end, and wherein the housing is configured to receive the plurality of storage containers via the second opening.

4. The system of claim 3, wherein the housing further comprises a third wall extending between the first wall and the second wall, wherein the first volume is defined between the first wall, the second wall, and a first side of the third wall, and a second volume is defined between the first wall, the second wall, and a second side of the third wall.

5. The system of claim 4, wherein the second opening is defined by the first wall, the second wall, and the first side of the third wall, and a third opening is defined by the first wall, the second wall, and the second side of the third wall.

6. The system of claim 3, wherein the housing further comprises a fourth wall positioned at the housing second end and extending from the first wall towards the second wall, wherein the fourth wall and the second wall cooperate to define the first opening.

7. The system of claim 1, further comprising:
a track positioned on an inner surface of the housing, a track first end of the track positioned proximate the housing first end and a track second end of the track positioned proximate the first opening; and
a plate coupled to the track and movable between the track first end and the track second end.

8. The system of claim 7, further comprising a biasing member positioned within the track, the biasing member biasing the plate towards the track second end.

9. The system of claim 1, wherein at least one of:
the second actuator is coupled to the first actuator such that the second actuator prevents the second actuator from being actuated from the second actuator second position to the second actuator first position when the first actuator is in the first actuator second position; or
the second actuator is coupled to the first actuator such that the first actuator prevents the second actuator from being actuated from the second actuator second position to the second actuator first position when the first actuator is in the first actuator second position.

10. The system of claim 1, further comprising one or more mounting members positioned on a rear surface of the housing wall, the one or more mounting members configured to couple the housing to a surface.

11. A system comprising:
a housing having a housing first end and a housing second end and defining a first volume and a first opening in communication with the first volume;
a tray pivotably coupled to the housing within the first volume and positioned proximate the first opening, wherein the tray is repositionable between a first tray position and a second tray position;
an arm pivotably coupled to the housing within the first volume and positioned between the housing first end and the housing second end, wherein the arm is repositionable between a first arm position and a second arm position; and
a first storage container positionable within the first volume;
wherein the tray contacts the first storage container of a plurality of storage containers when the tray is in the first tray position.

12. The system of claim 11, further comprising a second storage container positionable within the first volume such that the arm contacts the second storage container of the plurality of storage containers when the arm is in the second arm position.

13. The system of claim 11, further comprising a first actuator positioned on an outer surface of the housing, the first actuator coupled to the tray, the first actuator actuatable between a first actuator first position whereby the first actuator causes the tray to pivot to the first tray position and a first actuator second position whereby the first actuator causes the tray to pivot to the second tray position.

14. The system of claim 13, further comprising a second actuator positioned on the outer surface of the housing, the second actuator coupled to the arm, the second actuator actuatable between a second actuator first position whereby the second actuator causes the arm to pivot to the first arm position and a second actuator second position whereby the second actuator causes the arm to pivot to the second arm position.

15. The system of claim 14, wherein the second actuator is coupled to the first actuator such that:
the second actuator prevents the first actuator from being actuated from the first actuator first position to the first actuator second position when the second actuator is in the second actuator first position; and
the first actuator prevents the second actuator from being actuated from the second actuator second position to the second actuator first position when the first actuator is in the first actuator second position.

16. The system of claim 14, wherein:
the housing defines a second volume, the first opening in communication with the second volume;
the arm extends from a first lateral side of the housing to a second lateral side of the housing, opposite the first lateral side, such that the arm extends into the first volume and the second volume;
the first actuator is positioned on a front surface of the housing; and
the second actuator is positioned on a side surface of the housing.

17. A method comprising:
providing a dispensing system comprising:
a housing defining a first volume and a first opening:
a tray pivotably coupled to the housing within the first volume, wherein the tray is repositionable between a first tray position and a second tray position;
an arm pivotably coupled to the housing within the first volume, wherein the arm is repositionable between a first arm position and a second arm position;
a first actuator positioned on an outer surface of the housing and coupled to the tray, the first actuator actuatable between a first actuator first position whereby the first actuator causes the tray to pivot to the first tray position and a first actuator second position whereby the first actuator causes the tray to pivot to the second tray position; and
a second actuator positioned on the outer surface of the housing and coupled to the arm, the second actuator actuatable between a second actuator first position whereby the second actuator causes the arm to pivot to the first arm position and a second actuator second position whereby the second actuator causes the arm to pivot to the second arm position;
positioning a plurality of storage containers within the first volume, such that the tray contacts a first storage container of the plurality of storage containers; and
actuating the second actuator from the second actuator first position to the second actuator second position, thereby causing the arm to contact a second storage container of the plurality of storage containers.

18. The method of claim 17, further comprising, subsequent to actuating the second actuator from the second actuator first position to the second actuator second position, actuating the first actuator from the first actuator first position to the first actuator second position, thereby causing the tray to release the first storage container.

19. The method of claim 18, further comprising, subsequent to actuating the first actuator from the first actuator first position to the first actuator second position, actuating the first actuator from the first actuator second position to the first actuator first position, thereby causing the tray to pivot from the second tray position to the first tray position.

20. The method of claim 19, further comprising, subsequent to actuating the first actuator from the first actuator second position to the first actuator first position, actuating the second actuator from the second actuator second position to the second actuator first position, thereby causing the arm to pivot from the second arm position to the first arm position.
